(19) United States
(12) Patent Application Publication
(10) Pub. No.: US 2025/0286763 A1
(43) Pub. Date: Sep. 11, 2025

(54) METHOD AND APPARATUS USING HYBRID RF-DOMAIN AND BASEBAND-DOMAIN SENSING SIGNAL

(71) Applicant: Huawei Technologies Co., Ltd., Shenzhen (CN)

(72) Inventors: Alireza Bayesteh, Brossard (CA); Jianglei Ma, Ottawa (CA); Wen Tong, Ottawa (CA)

(21) Appl. No.: 19/198,827

(22) Filed: May 5, 2025

Related U.S. Application Data
(63) Continuation of application No. PCT/CN2022/133961, filed on Nov. 24, 2022.

(51) Int. Cl. H04L 27/26; G01S 7/00; G01S 7/282; G01S 13/86; H04W 76/11

(52) U.S. Cl. CPC H04L 27/26136; G01S 7/006; G01S 7/282; G01S 13/86; H04W 76/11

(57) ABSTRACT

A sensing signal may be selected from a sensing signal pool that has been expanded on the basis of one or more extra signal configuration parameters. That is, the sensing signal pool has an increased signature space relative to sensing signals designs that are based on only two signal configuration parameters. Furthermore, an appropriately selected sensing signal may be shown to enable low-complexity and low power mode sensing detection for relatively low capability nodes. A sensing signal may be generated from amongst a plurality of sensing signals that may be understood to form a pool of sensing signals, where the sensing signals in the pool have attributes in both the RF domain and the baseband domain.

### CROSS-REFERENCE TO RELATED APPLICATION

This application is a continuation of International Application No. PCT/CN2022/133961, filed on Nov. 24, 2022, titled “METHOD AND APPARATUS USING HYBRID RF-DOMAIN AND BASEBAND-DOMAIN SENSING SIGNAL,” which is hereby incorporated by reference in its entirety.

### TECHNICAL FIELD

The present disclosure relates, generally, to sensing in wireless communication environments and, in particular embodiments, method and apparatus to use, for such sensing, of a hybrid radio-frequency-domain and baseband-domain sensing signal.

### BACKGROUND

Known fifth generation (5G) new radio (NR) mobile wireless communication standards include nodes capable of sensing and nodes capable of communication. It is expected that future networks, i.e., sixth generation (6G) networks, will have nodes capable of both sensing and communication. As a result, the number of sensing nodes and sensing pairs may be expected to scale up significantly as a distribution of nodes becomes increasingly dense. In many sensing applications, a sensing report is generated and transmitted to a network node. The network node is given a task of processing a plurality of received sensing reports and acting on the basis of information obtained through the processing. The context of a received sensing report may be understood to be enhanced by an association between the received sensing report and an identifier (ID) of the sensing node that is the source of the sensing report. Alternatively, the received sensing report may have an association with a sensing session ID. Furthermore, it may be shown to be beneficial to establish mechanisms that allow sensing nodes to distinguish between sensing signals transmitted by different nodes.

### SUMMARY

Aspects of the present application address a problem of distinguishability of sensing signals and a problem of how to allow for a radio frequency (RF) dominant mode of sensing for low processing power nodes. For low processing power nodes, low processing power may be associated to several features of the node. Most importantly, low processing power may be associated to the fact that the node might be in the low power mode for power saving. A sensing signal may be selected from a sensing signal pool that has been expanded on the basis of one or more extra signal configuration parameters. That is, the sensing signal pool has an increased signature space relative to sensing signals designs that are based on only two signal configuration parameters: a starting frequency, f₀; and a chirp rate, α. Furthermore, an appropriately selected sensing signal may be shown to enable low-complexity and low power mode sensing detection for relatively low capability nodes. A sensing signal may be generated from amongst a plurality of sensing signals that may be understood to form a pool of sensing signals, where the sensing signals in the pool have attributes in both the RF domain and the baseband domain.

Current sensing solutions are known to draw certain amounts of power and rely on certain amounts of complexity. Additionally, current sensing solutions are known to be limited in their ability to allow a receiver to distinguish between sensing signals transmitted by distinct entities.

By allowing for low-complexity RF-dominant processing for user equipment (UE) in low power mode, low power consumption and low complexity operation are both enabled. UEs in normal power mode may exploit extra dimensions in the baseband domain to separate sensing signals received from distinct entities. By appropriately processing separate sensing signals, UEs in normal power mode may achieve a higher resolution sensing.

According to an aspect of the present disclosure, there is provided a method. The method includes generating a linearly frequency modulated signal, generating a signature function, obtaining a sensing signal by modulating the linearly frequency modulated signal with the signature function and transmitting the sensing signal.

According to an aspect of the present disclosure, there is provided a device. The device includes a linearly frequency modulated signal generator configured to generate a linearly frequency modulated signal, a signature function generator configured to generate, in a digital domain, a signature function, a multiplier configured to modulate the linearly frequency modulated signal with the signature function to, thereby, obtain a sensing signal and a transmitter configured to transmit the sensing signal.

According to an aspect of the present disclosure, there is provided an apparatus. The apparatus comprises at least one processor coupled with a memory storing instructions which, when the instructions are executed by the at least one processor, cause the apparatus to carry out the any one of method shown above. The apparatus may be chipsets. or the apparatus may be a module/unit in a device.

According to an aspect of the present disclosure, there is provided a communication system. The system comprise the device or apparatus mentioned above and a device that receiving the sensing signal.

According to an aspect of the present disclosure, there is provided a computer program. The computer program comprises instructions which, when the program is executed by a computer, cause the computer to carry out the any one of method shown above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a wireless communication environment including first TRP, a second TRP, a first UE, a second UE, a first reflector and a second reflector;

FIG. 7 illustrates transmitter elements involved in generating a sensing signal for transmission, according to aspects of the present application;

FIG. 8A illustrates receiver elements involved in analyzing a sensing signal after the sensing signal has been received, according to aspects of the present application;

FIG. 8B illustrates receiver elements involved in analyzing a sensing signal after the sensing signal has been received, in a configuration distinct from the receiver elements of FIG. 8A, according to aspects of the present application;

FIG. 9 illustrates an example frequency hopping implementation for a signature function, according to aspects of the present application;

FIG. 10 illustrates a plot of output power with respect to delay for output from the chirp processing receiver in FIG. 8B given a first received sensing signal as input, according to aspects of the present application;

FIG. 11 illustrates a plot of output power with respect to delay for output from the chirp processing receiver in FIG. 8B given a second received sensing signal as input, according to aspects of the present application;

FIG. 12 illustrates an example base sequence codebook implementation for a signature function, according to aspects of the present application;

FIG. 13 illustrates a plot of output power with respect to delay to show an example delta train, according to aspects of the present application;

FIG. 14 illustrates a plot of output power with respect to delay for output from the chirp processing receiver in FIG. 8B given a received base sequence codebook-based sensing signal as input, according to aspects of the present application;

FIG. 15 illustrates a table that associates a quantity of signature functions in terms of the number of non-zero IDFT codeword elements, according to aspects of the present application;

FIG. 16 illustrates transmitter elements involved in generating a sensing signal for transmission, according to aspects of the present application; and

FIG. 17 illustrates another transmitter element involved in generating a sensing signal for transmission, according to aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

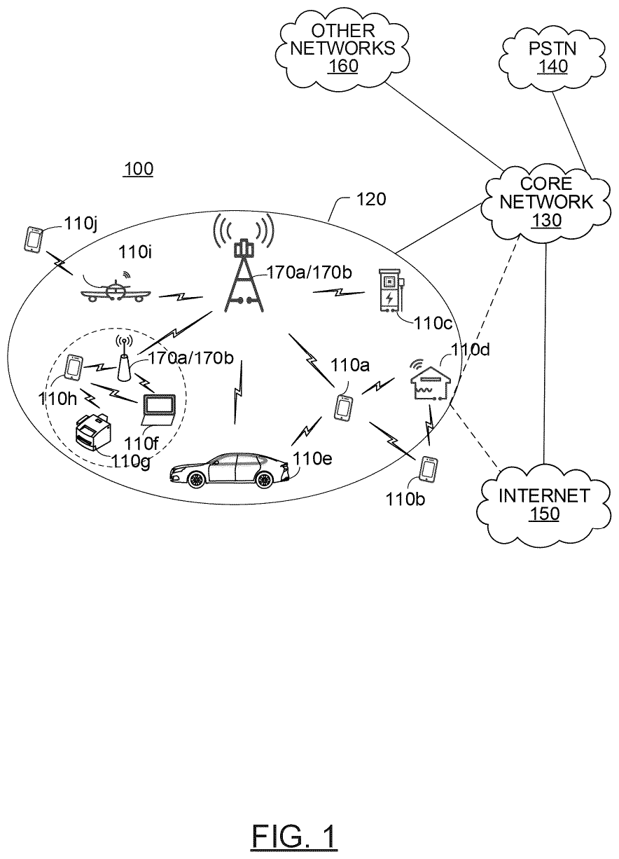

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another and/or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

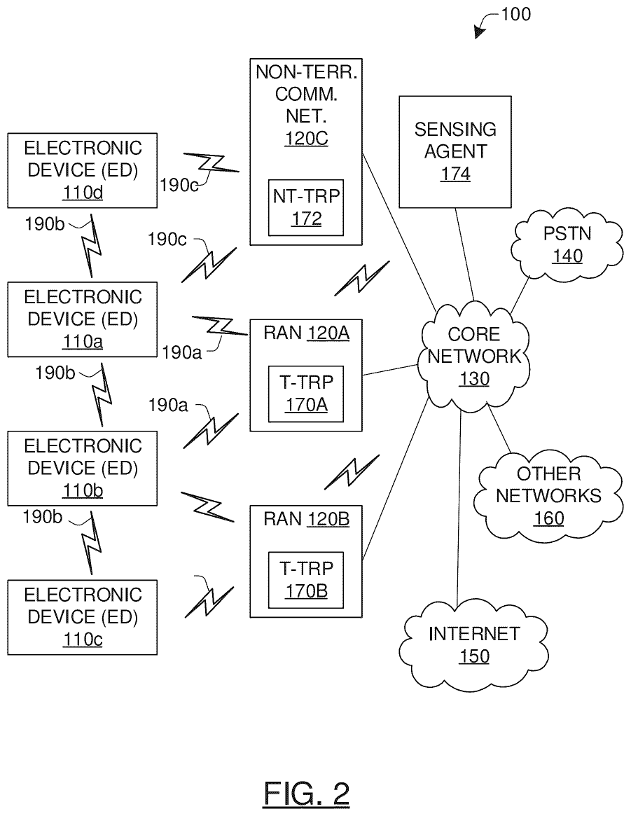

FIG. 2 illustrates an example communication system 100. In general, the communication system 100 enables multiple wireless or wired elements to communicate information. The purpose of the communication system 100 may be to provide information, such as voice, data, video, signaling, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link. In the following, “a wireless link” may be referenced, more simply, as “a link.” For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

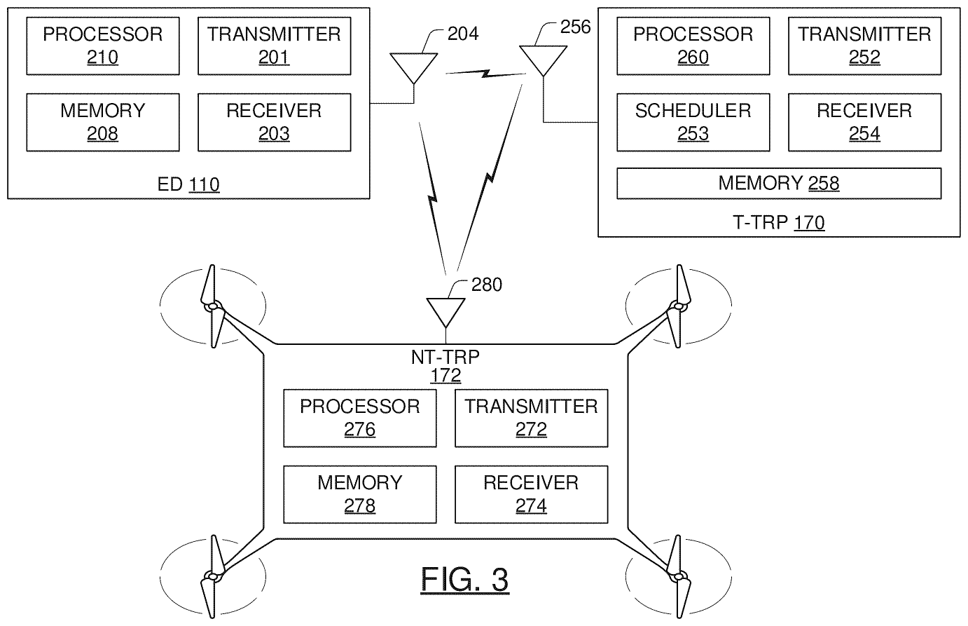

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 may include at least one memory 208. The memory 208 stores instructions and/or data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources.

The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

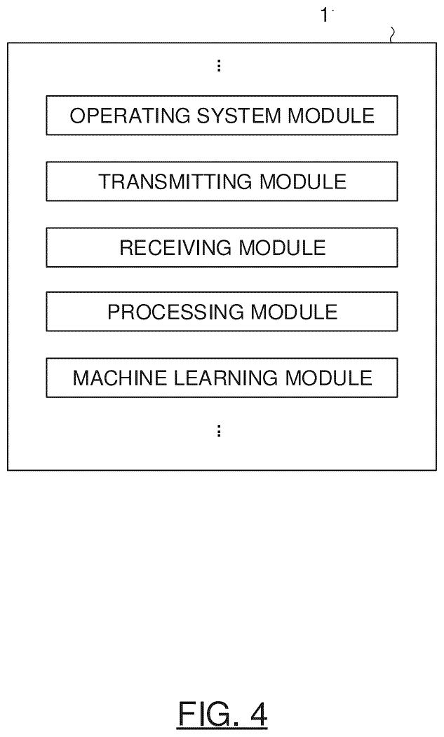

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code, subcarrier spacing, cyclic prefix length or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occur on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common (or group) control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The above mentioned configuration parameters may be signaled via, but not limited to, radio resource control (RRC) layer signaling, media access control (MAC) layer signaling, physical layer signaling (e.g., downlink control information) or any combination.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency of the carrier, the lowest frequency of the carrier, the highest frequency of the carrier or a reference point that is outside the carrier and an offset. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 in FIG. 2 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

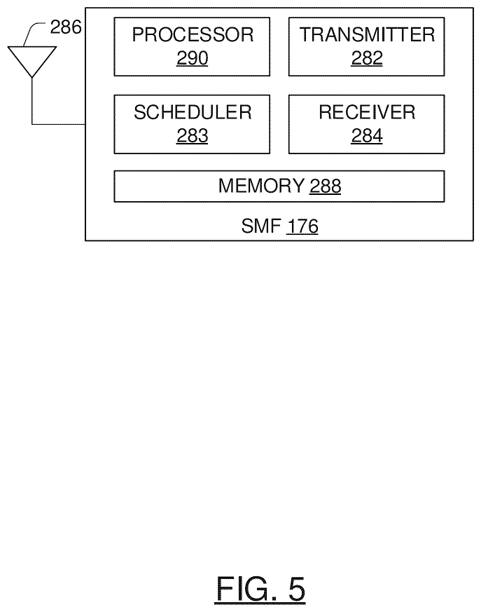

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing-based technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) waveforms and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linearly frequency modulated signal, also called a linear chirp signal, with bandwidth, B, and time duration, T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as a chirp rate. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt2} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

Due to heterogeneity between sensing node capabilities, it may be shown to be beneficial to design sensing signals with a flexibility of being able to be processed in the RF domain. To be clear, the reference to processing in the RF domain does not, necessarily, mean that all processing tasks are carried out in the RF domain. There may be some, limited, baseband processing. However, it is expected that the baseband processing rates very low-in measurements of complexity and rates low in measurements of power consumption. Sometimes, herein, the processing of sensing signals in the RF domain may be referenced as RF-dominant processing, and may be shown to allow for a possibility of some, limited, baseband processing. Conveniently, the processing of sensing signals in the RF domain may be associated with relatively low complexity relative to the processing of sensing signals in the baseband domain. Accordingly, it may be shown that a UE with relatively low capability may participate in a sensing session by processing sensing signals in an RF-dominant manner.

One candidate for a sensing signal with flexibility of being able to be processed in the RF domain is a known “linearly frequency modulated signal” (also known as a “chirp signal”). That is, both the term “linearly frequency modulated signal” and the term “chirp signal” refer to the same type of signal, whose frequency is changing with time in a linear fashion. The chirp signal has a long history in radar applications. The chirp signal may be represented, mathematically, as c(t)=e^{j2πf}^{₀}^{t}e^{jπαt2}. The chirp signal may be considered to have two dimensions (chirp signal configuration parameters) that allow for distinguishability: a starting frequency, f₀, which may also be referenced as a frequency offset; and a chirp rate, α. The chirp rate, α, may be defined as a quotient of bandwidth, B, and the time duration, T, of the linear chirp signal. That is,

$$α = \frac{B}{T} .$$

Existing sensing signal approaches may be categorized either as a radar-based approach or as a communication-based approach.

In the radar-based approach, a traditional radar waveform is adapted to be used as a sensing signal in a wireless communication system. A popular sensing signal design involves use of a chirp-based waveform, which may also be called FMCW waveform or in particular, a Linear Frequency-Modulated Continuous Wave (LFM-CW) waveform. A chirp-based waveform may be defined using chirp signal configuration parameters (e.g., starting frequency and chirp rate) that may be used to define a node-specific sensing signal. That is, a receiver may obtain a starting frequency and a chirp rate for a received chirp waveform and determine, from information associating chirp signal configuration parameters with node IDs, an ID for the node that transmitted the received chirp signal. It may be stated, then, that chirp signal configuration parameters act as a manner by which a node transmitting a chirp waveform may be identified. The radar-based approach, as mentioned before, may be shown to provide a relatively low-complexity and flexible design. Accordingly, the radar-based approach may be understood to be suited to processing by devices with relatively low capabilities or by devices operating in a low power mode.

In the communication-based approach, communication signals (e.g., OFDM waveform signals) are reused for the purpose of sensing. Since the sensing configuration is multi-static, the sensing signal may be a pilot signal that is known to the receiver.

Notably, the two signal configuration parameters used in the radar-based approach may be insufficient for distinguishing among a plurality of sensing signals transmitted from a corresponding plurality of different nodes for future applications. This may be referred to as a lack of sufficient signature space.

Further notably, to keep overhead low in the communication-based approach, the pilot signals are only transmitted in a relatively sparse manner. Indeed, the sparseness of the pilot signals may make the communication-based approach unsuitable for sensing. In addition, the communication-based approach involves processing pilot signals in the baseband domain. The processing of pilot signals in the baseband domain may be shown to make the communication-based approach unsuitable for devices in low power mode operation due to power consumption associated with converting analog signals to digital signals for processing in the baseband domain.

Aspects of the present application relate to finding one or more extra signal configuration parameters for a sensing signal design. More signal configuration parameters may be shown to allow for a larger pool of sensing signals.

In overview, aspects of the present application relate to carrying out sensing with a sensing signal selected from a sensing signal pool that has been expanded on the basis of one or more extra signal configuration parameters. That is, the sensing signal pool has an increased signature space relative to sensing signals designs that are based on only two signal configuration parameters. Furthermore, an appropriately selected sensing signal may be shown to enable low-complexity and low power mode sensing detection for relatively low capability UEs. The sensing signals in the sensing signal pool may be generically represented, mathematically, as x(t)=s(t)e^{j2πf}^{₀}^{t+jπαt}, where a function, s(t), is representative of a signature function embedded in the baseband domain and e^{j2πf}^{₀}^{t+jπαt} is representative of a legacy chirp waveform, which may be generated and processed in the RF domain. It follows that a sensing signal may be generated from amongst a plurality of sensing signals that may be understood to form a pool of sensing signals, where the sensing signals in the pool have attributes in both the RF domain and the baseband domain. The sensing signal pool may be characterized by a signature space, {f₀, α, rₛ}, where rₛ represents an index for the signature function, s(t). The index, rₛ, may be considered to provide, to a generated sensing signal, an extra degree of freedom in contrast to a sensing signal generated on the sole basis of the legacy chirp waveform.

Aspects of the present application may be understood to be applicable to a multi-node sensing scenario, wherein a network of UEs 110 with different capabilities and operating in different power modes are to perform sensing tasks. Aspects of the present application are often described, hereinafter, from the perspective of a UE 110. However, it should be clear that further aspects of the present application may relate to a perspective of a TRP (e.g., a TN-TRP 170 or an NTN-TRP 172) with different capabilities and operating in different power modes. There are three main devices/nodes that may be involved in the proposed procedures: UEs/nodes 110 operating in low power mode; UEs/nodes 110 operating in normal power mode; and TRPs 170/172 or base stations.

The UEs/nodes 110 operating in a low power mode may be shown to enter low power mode to save energy. Aspects of the present application relate to designing a sensing signal on the basis of which the UEs/nodes 110 operating in low power mode can obtain sensing information while consuming minimal processing power. Reductions in use of power, relative to UEs/nodes operating in normal power mode, may be realized through the use of RF-dominant processing. Use of RF-dominant processing may be shown to allow for transmission of high bandwidth signals. In turn, use of high bandwidth signals may be shown to allow the UEs/nodes 110 to achieve relatively high resolution sensing, even while operating in low power mode.

The UEs/nodes 110 operating in a normal power mode may include UEs 110 operating in an RRC CONNECTED state and may include other network-controlled nodes defined as carrying out normal operations. The other network-controlled nodes defined as carrying out normal operations are often the nodes with relatively high processing power and capability. Aspects of the present application relate to designing a sensing signal with increased signature space to allow these nodes to perform high accuracy sensing through digital baseband processing in order to distinguish the sensing signals.

The TRPs 170/172 or base stations may be understood to be in charge of providing configurations for sensing operations and sensing signals. More particularly, the TRPs 170/172 or base stations may act to optimize the sensing signals based on the desired accuracy, desired resolution, known node density and known reflectors in the wireless environment.

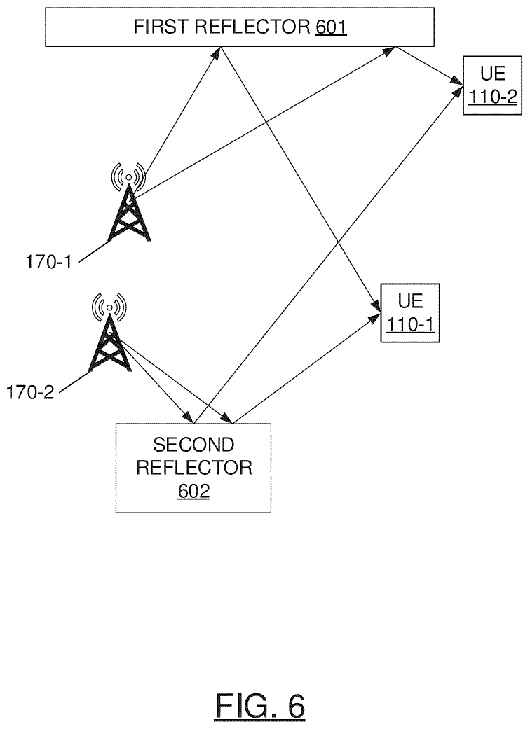

FIG. 6 illustrates a wireless communication environment including first TRP 170-1, a second TRP 170-2, a first UE 110-1 and a second UE 110-2. The environment further includes a first reflector 601 and a second reflector 602. The first UE 110-1 may be understood to be operating in a mode of operation that is normal in respect of power use. In contrast, the second UE 110-2 may be understood to be operating in a power saving mode of operation.

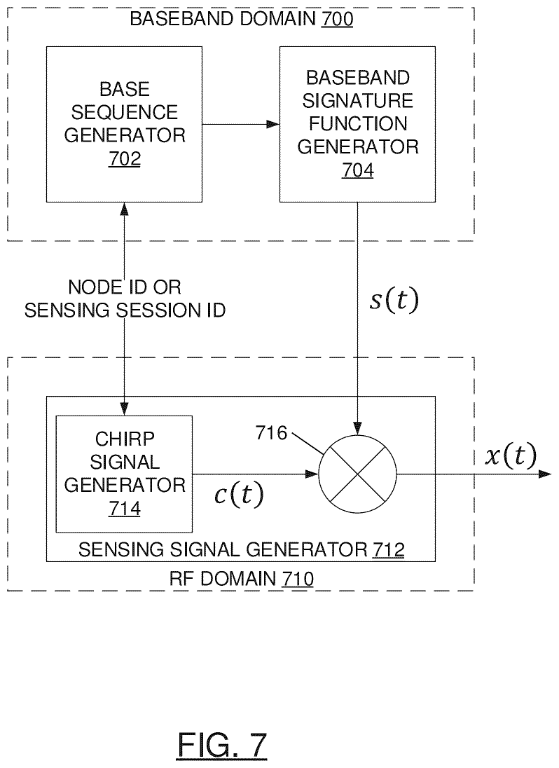

FIG. 7 illustrates transmitter elements involved in generating a sensing signal, x(t), for transmission. Some of the generating takes place in a baseband domain 700 and some of the generating takes place in an RF domain 710. The baseband domain 700 includes a base sequence generator 702 and a baseband signature function generator 704. The RF domain 710 includes a sensing signal generator 712. The sensing signal generator 712 includes a chirp signal generator 714 and a modulator 716. The modulator 716 may be implemented as a multiplier.

In operation, the base sequence generator 702 may receive, as input, a node ID or a sensing session ID. On the basis of the received ID, the base sequence generator 702 may determine an index (a “codeword index”) that allows the base sequence generator 702 to select a particular codeword from among a plurality of codewords in a codebook. On the basis of the codeword index, the base sequence generator 702 may transmit, to the baseband signature function generator 704, a base sequence. On the basis of the base sequence, the baseband signature function generator 704 may generate a signature function, s(t). The baseband signature function generator 704 may then transmit, to the sensing signal generator 712, the signature function, s(t). The chirp signal generator 714 may also receive, as input, the same node ID or the same sensing ID that was provided to the base sequence generator 702. On the basis of the node ID or the sensing session ID, the chirp signal generator 714 may select a starting frequency, fᵢ, and a chirp rate, α. Using the selected starting frequency, fᵢ, and the selected chirp rate, α, the chirp signal generator 714 may generate a chirp signal. The chirp signal, c(t), at the output of the chirp signal generator 714 may be modulated, at the modulator 716, with the signature function, s(t), to, thereby, generate the sensing signal, x(t). The node ID may be an identity associated with the sensing transmitter (e.g., the first TRP 170-1 in FIG. 6) or an identity associated with the sensing receiver (e.g., the first UE 110-1 in FIG. 6).

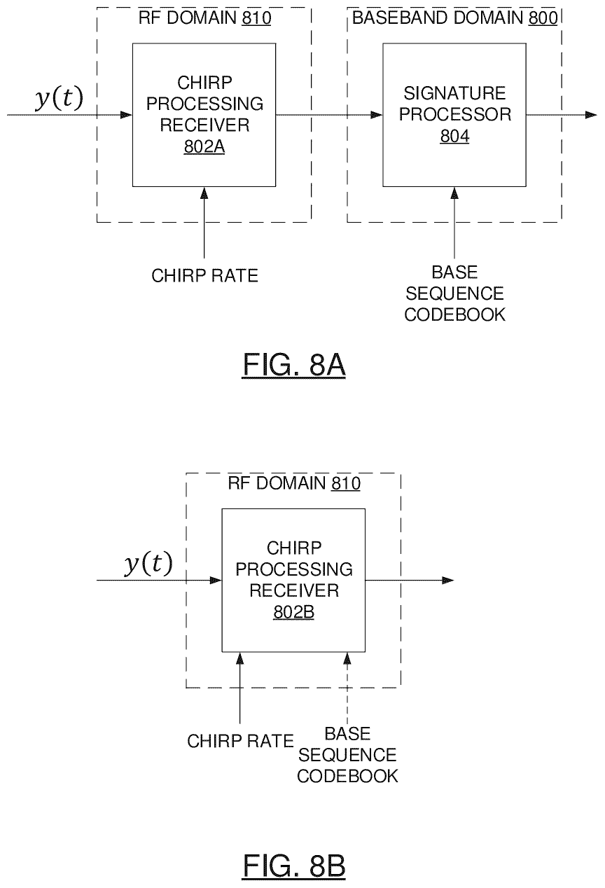

FIG. 8A illustrates receiver elements involved in analyzing a sensing signal after the sensing signal has been received. More specifically, the receiver elements illustrated in FIG. 8A may be understood to relate to the first UE 110-1 in FIG. 6, which is operating in a mode of operation that is normal in respect of power use. FIG. 8A illustrates receiver elements categorized in an RF domain 810 and in a baseband domain 800. The element in the RF domain 810 is a chirp processing receiver 802A. The element in the baseband domain 800 is a signature processor 804. The chirp processing receiver 802A in FIG. 8A is illustrated as receiving a chirp rate. It may not always be the case that the chirp processing receiver 802A receives a chirp rate. The signature processor 804 in FIG. 8A is illustrated as receiving a base sequence codebook. It may not always be the case that the signature processor 804 receives a base sequence codebook.

In operation, input to the chirp processing receiver 802A of FIG. 8A is a received sensing signal, y(t), which is a version of the transmitted sensing signal, x(t), that has been altered by a channel interposing the transmitter (e.g., a TRP 170) and the first UE 110-1. Output from the chirp processing receiver 802A in FIG. 8A is received at the signature processor 804. On the basis of the received base sequence codebook, the signature processor 804 processes the output of the chirp processing receiver 802A. The output of the signature processor 804 may then be processed to obtain the unknown signal configuration parameters, fᵢ and rₛ. In some embodiments, the chirp processing receiver 802A may, additionally, obtain the chirp rate, α.

FIG. 8B illustrates receiver elements involved in analyzing a sensing signal after the sensing signal has been received. More specifically, the receiver elements illustrated in FIG. 8B may be understood to relate to the second UE 110-2 in FIG. 6, which is operating in a power saving mode of operation. FIG. 8B illustrates a receiver element categorized in the RF domain 810. The element in the RF domain 810 is a chirp processing receiver 802B. The chirp processing receiver 802B in FIG. 8B is illustrated as receiving a chirp rate. The chirp processing receiver 802B in FIG. 8B is also illustrated as, optionally, receiving a base sequence codebook.

In operation, input to the chirp processing receiver 802B of FIG. 8B is a received sensing signal, y(t), which is a version of the transmitted sensing signal, x(t), that has been altered by a channel interposing the transmitter (e.g., a TRP 170) and the second UE 110-2. Output from the chirp processing receiver 802B in FIG. 8B may be processed to obtain the unknown signal configuration parameters, fᵢ and rₛ.

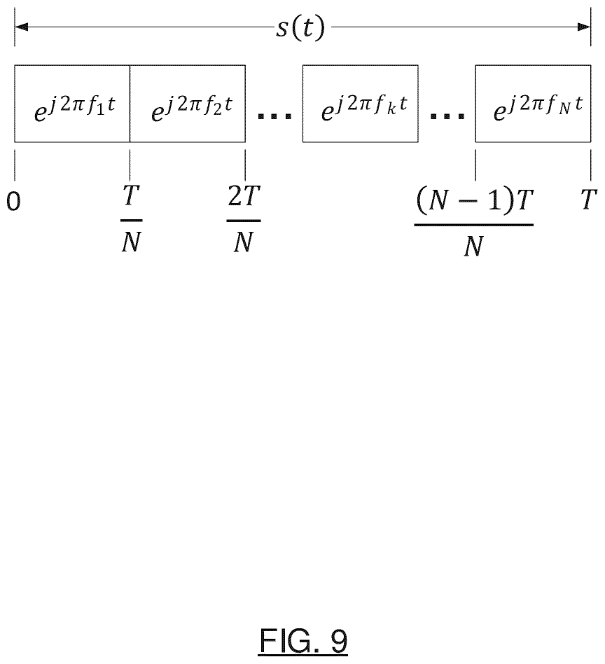

Aspects of the present application relate to a frequency hopping implementation for the design of the signature function, s(t). FIG. 9 illustrates an example frequency hopping implementation for the signature function, s(t). FIG. 9 illustrates a sensing time duration, T, that has been divided into a number, N, of time slots. The number, N, of time slots may be considered to be a design parameter. The signature function, s(t), illustrated in FIG. 9 includes a number of sinusoidal signals equal to the number, N, of time slots. That is, the TRP 170 may transmit a distinct sinusoidal signal in each of the time slots. The duration of the signature function time slots can be considered to be a design/configuration parameter. In some embodiments, the duration of each of the signature function time slots can be related with the duration of communication time slots.

The distinct sinusoidal signal for the k^{th} time slot may be mathematically represented as e^{j2πf}^{ₖ}^{t}. As discussed hereinbefore, the transmitted sensing signal, x(t), may be mathematically represented as x(t)=s(t) e^{jπαt}^{²}. A new signature space, Sₙ, associated with the transmitted sensing signal according to aspects of the present application may be defined as S=[f₁, f₂, . . . , fₖ, . . . , f_{N}, α]. The new signature space, Sₙ, may be shown to be much larger than an old signature space, Sₒ, associated with the traditional chirp sensing signal, with Sₒ=[f₀, α].

For simplicity of presentation, the frequency, fₖ, of the distinct sinusoidal signal in the k^{th} time slot may be may be expressed as portion of a bandwidth, B, of the sensing signal. For example, the frequency, fₖ, of the distinct sinusoidal signal in the k^{th} time slot may be may be defined as

$${f}_{k} = \frac{{r}_{k} B}{L} ,$$

where L and rₖ may each be referred to as an integer value. It follows that the sensing signal is different in each of the time slots, xₖ(t)=sₖ(t)e^{jπαt}^{²}, or, put another way, xₖ(t)=e^{j2ηf}^{ₖ}^{t}e^{jπαt}^{²}. In this example, instead of expressing the signature space in terms of frequencies, the signature space may be expressed in terms of a set of signature integers and a chirp rate, Sₙ=[r₁, r₂, . . . , rₖ, . . . , r_{N}, α].

Notably, a given set of signature integers, rₖ, k=0, . . . , N, may be represented as a signature vector, r=[r₁, r₂, . . . , rₖ, . . . , r_{N}]. Accordingly, a corresponding set of frequencies, fₖ, k=0, . . . , N, may be represented as a frequency vector, f=[f₁, f₂, . . . , fₖ, . . . , f_{N}]. The signature vector, r, and the frequency vector, f, may be related to one another in a single expression,

$$f = \frac{B}{L} r .$$

Two example transmitted sensing signals, x^{[1]}(t), x^{[2]}(t), may be generated by two distinct TRPs 170 using respective versions of the base sequence generator 702, the baseband signature function generator 704, the chirp signal generator 714 and the modulator 716 illustrated in FIG. 7.

A first example transmitted sensing signal, x^{[1]}(t), may be configured to have a bandwidth, B, of 1 GHz and a signature function associated with L equal to 16. The baseband signature function generator 704 that is associated with the transmission of first example transmitted sensing signal, x^{[1]}(t), may be configured to employ a first signature vector, r₁, where r₁=[1, 14, 4, 3].

A second example transmitted sensing signal, x^{[2]}(t), may be configured to have a bandwidth, B, of 1 GHz and a signature function associated with L equal to 16. The baseband signature function generator 704 that is associated with the transmission of second example transmitted sensing signal, x^{[2]}(t), may be configured to employ a second signature vector, r₂, where r₂=[7, 2, 10, 4].

The first example transmitted sensing signal, x^{[1]}(t), may be received, at the chirp processing receiver 802B in FIG. 8B, as a first received sensing signal, y^{[1]}(t). Similarly, the second example transmitted sensing signal, x^{[2]}(t), may be received, at the chirp processing receiver 802B in FIG. 8B, as a second received sensing signal, y^{[2]}(t).

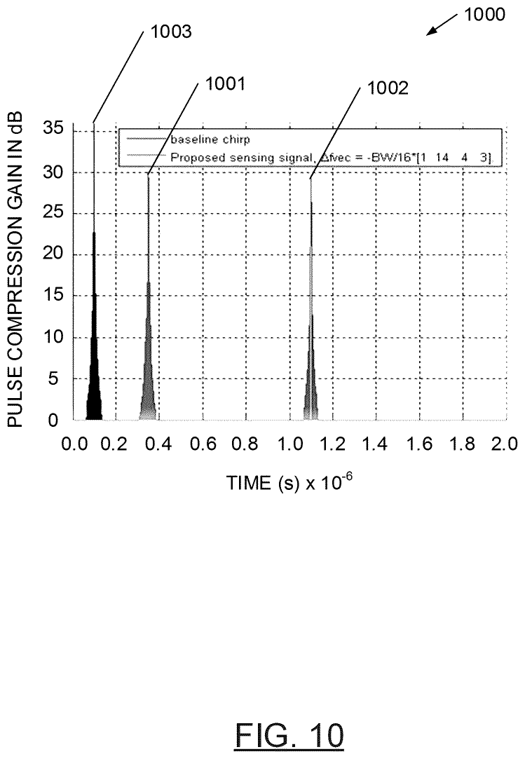

FIG. 10 illustrates a plot 1000 of output power with respect to delay for output from the chirp processing receiver 802B in FIG. 8B given the first received sensing signal, y^{[1]}(t), as input. The plot 1000 of FIG. 10 is representative of a case wherein the chirp processing receiver 802B is unaware of the first signature vector, r₁, and, accordingly, the chirp processing receiver 802B has not performed further processing that would make use of the first signature vector, r₁.

Three output patterns are illustrated in the plot 1000 of FIG. 10, with each output pattern having a peak associated with a reference numeral.

The reference numeral 1001 is associated with a first peak, representative of an output power pattern that is expected to be generated by the chirp processing receiver 802B responsive to first received sensing signal, y^{[1]}(t), that is the received version of a chirp signal that has been modulated by a signature function that makes use of the first signature vector, r₁=[r₁, r₂, . . . , rₖ, . . . , r_{N}]=[1, 14, 4, 3].

The reference numeral 1002 is associated with a second peak, representative of an output power pattern that is expected to be generated by the chirp processing receiver 802B responsive to the first received sensing signal that is the received version of a chirp signal that has been modulated by a signature function that makes use of the first signature vector, r₁=[r₁, r₂, . . . , rₖ, . . . , r_{N}]=[1, 14, 4, 3].

The reference numeral 1003 is associated with a third peak, representative of an output power pattern that is expected to be generated by the chirp processing receiver 802B responsive to receiving a sensing chirp signal that is unaffected by a signature function, or with a signature function, s(t)=1.

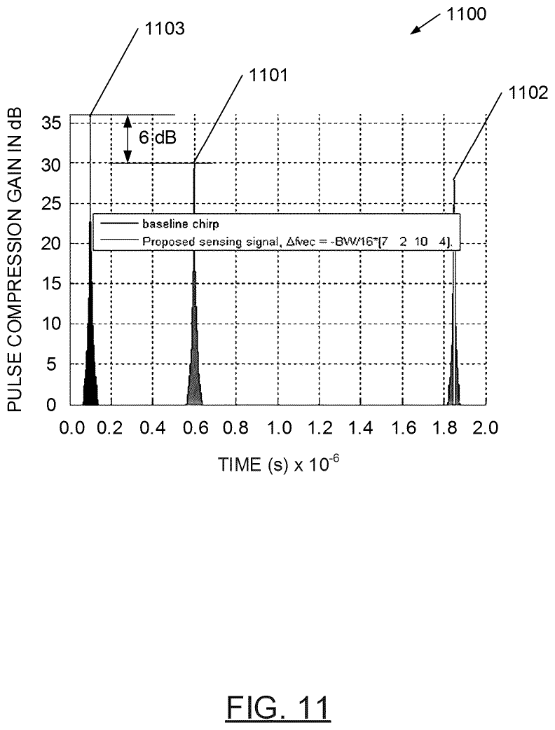

FIG. 11 illustrates a plot 1100 of output power with respect to delay for output from the chirp processing receiver 802B in FIG. 8B given the second received sensing signal, y^{[2]}(t), as input. The plot 1100 of FIG. 11 is representative of a case wherein the chirp processing receiver 802B is unaware of the second signature vector, r₂, and, accordingly, the chirp processing receiver 802B does not perform further processing that would make use of the second signature vector, r₂.

Three output patterns are illustrated in the plot 1100 of FIG. 11, with each output pattern having a peak associated with a reference numeral.

The reference numeral 1101 is associated with a first peak, representative of an output power pattern that is expected to be generated by the chirp processing receiver 802B responsive to the second received sensing signal that is the received version of a chirp signal that has been modulated by a signature function that makes use of the second signature vector, r₂=[r₁, r₂, . . . , rₖ, . . . , r_{N}]=[7, 2, 10, 4].

The reference numeral 1102 is associated with a second peak, representative of an output power pattern that is expected to be generated by the chirp processing receiver 802B responsive to the second received sensing signal that is the received version of a chirp signal that has been modulated by the signature function that makes use of the second signature vector, r₂=[r₁, r₂, . . . , rₖ, . . . , r_{N}]=[7, 2, 10, 4].

The reference numeral 1103 is associated with a third peak, representative of an output power pattern that is expected to be generated by the chirp processing receiver 802B responsive to receiving a sensing chirp signal that is unaffected by a signature function, or with a signature function, s(t)=1.

It is notable that the output power patterns 1001, 1002, (see FIG. 10) generated by receipt of transmitted sensing signals with a single signature function and the output power pattern 1003 generated by receipt of a sensing chirp signal that is unaffected by a signature function, or with a signature function, s(t)=1. Similarly, the output power patterns 1101, 1102 (see FIG. 11) are generated by receipt of transmitted sensing signals with a signature function that is distinct from the signature function used for the transmitted sensing signals that may be shown to lead to the output power patterns 1001, 1002. Aspects of the present application relate to using the difference in output power patterns to distinguish between different received sensing signals, even if only the chirp processing receiver 802B is used.

Although the output power pattern with first peak 1001 of FIG. 10 does not match the output power pattern with the third peak 1003, it may be shown that there is a deterministic relation between the observed peaks 1001, 1003. The relationship can be expressed as

$${t}_{obs} = {t}_{true} + \frac{Tk}{L} ,$$

for some integer value k, wherein t_{obs} denotes the time of the first peak 1001 and tₜᵣᵤₑ denotes the time of the third peak 1003, which corresponds to the true value of the parameter to be estimated. In the example shown in FIG. 10, L=16 and T=4 μs. Accordingly, the difference,

$$\frac{Tk}{L} ,$$

is 0.25 k μs for some integer, k. It follows that an estimate for the time of the third peak 1003 may be determined by trying a few hypotheses on the basis of some rough prior knowledge of a sensing parameter of interest.

It may be shown that there is no loss of resolution in output power pattern, at the output of the chirp processing receiver 802B, due to the application of the signature function at the sensing signal generator 712 (see FIG. 7). That is, the width of the output power pattern with the first peak 1001 is the same as the width of the output power pattern with the third peak 1003.

Notably, however, there is a difference in the peak powers. The difference in the peak powers may be shown to affect sensing accuracy. The difference in the peak powers may be shown to be due to a loss in the processing gain as a result of non-coherent combining at the output of a pulse compression filter (not shown) in the chirp processing receiver 802B.

In the plot 1100 of FIG. 11, a difference between the power of the first peak 1101 and the power of the third peak 1103 is illustrated as a 6 dB loss. The magnitude (6 dB) of the processing loss in this case may be directly related to the use of four time slots (N=4) for each signature function, s(t). It may be shown that the processing loss may be compensated for, by so-called high-capability UEs, through the use of specialized digital processing techniques that rely upon knowledge of the signature function, s(t).

Aspects of the present application relate to an implementation for the design of the signature function, s(t), that allows the received sensing signal to have the same properties as a received sensing chirp signal, y(t), that is unaffected by a signature function, these properties including auto-correlation.

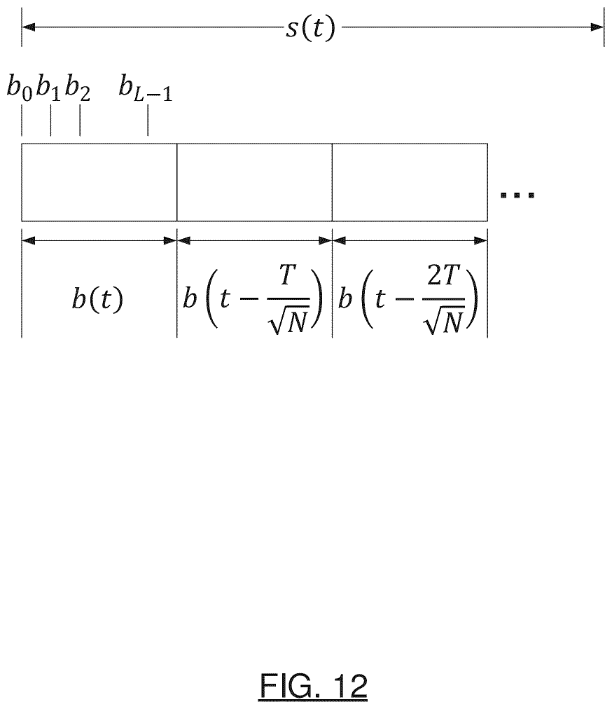

FIG. 12 illustrates an example base sequence codebook implementation for the signature function, s(t). FIG. 12 illustrates a sensing time duration, T, that has been divided into a number, L, of time slots. The number, L, of time slots may be considered to be based on at least two design parameters: the sensing time duration, T; and a bandwidth, B. Indeed, the two design parameters may be combined as a time-bandwidth product, N=BT. The integer value, L, may be understood to represent an integer number of time slots that is related to the time-bandwidth product by an expression L=\sqrt{N}.

The signature function, s(t), illustrated in FIG. 12 includes a number of signals equal to L. That is, the TRP 170 may transmit a distinct signal in each of the L time slots. Defining the signature function, s(t), may involve first defining a base signal, b(t). In turn, the base signal, b(t), may be defined on the basis of a base sequence, [b₀, b₁, b₂, . . . , b_{L-1}]. More particularly, the base signal, b(t), may be obtained by using the base sequence to alter a selected pulse shape.

In a case wherein the selected pulse shape is a rectangular pulse shape, the base signal may be expressed as a sum of products of symbols, bᵢ, in the base sequence and a shifted version of the known rect function:

$$b ( i ) = {\sum }_{i = 0}^{L - 1} {b}_{i} Π ( B ( t - \frac{i}{B} ) )$$

where Π(·) is representative of the known rect function:

$$Π ( a ) = \{ \begin{matrix}0 , if \vert α \vert > \frac{1}{2} \\ \frac{1}{2} , if \vert α \vert = \frac{1}{2} \\ 1 , if \vert α \vert < \frac{1}{2}\end{matrix}$$

Notably, the known rect function is the Fourier transform of the known sinc function. Recall that the known sinc function may be expressed as:

$$sinc ( π f ) = \frac{sin ( π f )}{π f} = \frac{1}{2 π} {\int }_{- ∞}^{∞} Π ( t ) \cdot {e}^{- j 2 π ft} dt$$

### Notably, Π(Bt)≠0,

$$t ∈ [ 0 , \frac{1}{B} = \frac{T}{N} ] .$$

The signature function, s(t), is illustrated, in FIG. 12, as being formed as a plurality of shifted versions of the base signal, b(t). Accordingly, the signature function, s(t), may be expressed as:

$$s ( t ) = {{\sum }^{\sqrt{N} - 1}}_{k = 0} b ( t - \frac{kT}{\sqrt{N}} )$$

It may be considered that the base sequence may be expressed as a base sequence codeword, \vec{b}=(b₀, . . . , b_{L-1}), where the integer value, L, may be determined from an expression, L=\sqrt{N}. Aspects of the present application relate to use of a base sequence codeword that has been designed in a specific manner.

In view of the function, y(t), being representative of the output of the chirp processing receiver 802A responsive to receipt of an unmodulated chirp signal, then an output, z(t), of the chirp processing receiver 802A responsive to receipt of a signal transmitted as a chirp signal modulated by the signature function, s(t), of FIG. 12 can be shown to be mathematically well-approximated by

$$z ( t ) = {\sum }_{k = 0}^{L - 1} \vert {B}_{k} \vert y ( t - \frac{kT}{L} )$$

where an IDFT codeword, \vec{B}=(B₀, . . . , B_{L-1}), is an Inverse Discrete Fourier Transform (IDFT) of the base sequence codeword, \vec{b}=(b₀, . . . , b_{L-1}).

It may be shown that the function, y(t), at the output of the chirp processing receiver 802A responsive to receipt of an unmodulated chirp signal is a sinc function, which is similar to the known delta function for a relatively large time-bandwidth product, BT.

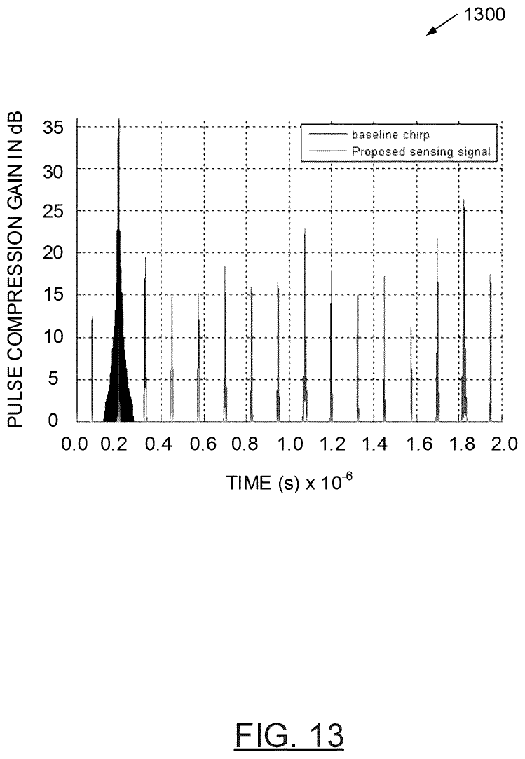

Is follows that the output, z(t), of the chirp processing receiver 802A responsive to receipt of a signal transmitted as a chirp signal modulated by the signature function, s(t), of FIG. 12 may be shown to be similar to a delta train (sinc functions of narrow width) with each delta function having a distinct weight. An example delta train is illustrated in a plot 1300 in FIG. 13. Notably, it may be shown that there is no resolution loss. In other words, a universal receiver can still distinguish different delays due to targets with different ranges (range resolution). For a j^{th} UE 110-j, an estimated delay, \hat{τ}ⱼ, may be determined on the basis of a true delay, τⱼ, on the basis of the sensing signal time duration, T, and the number, L, of time slots, using an expression,

$${\hat{τ}}_{j} = {τ}_{j} + \frac{kT}{L}$$

for some integer, k.

It may be understood that, however, the power of each sinc pulse at the output of the chirp processing receiver 802A is lower than the power of the single sinc pulse corresponding to the unmodulated chirp due to the loss of the processing gain caused by non-coherent detection. It may also be understood that the weight of the k^{th} sinc pulse in the output, z(t), is proportional to the k^{th} element in the IDFT codeword, \vec{B}=(B₀, . . . , B_{L-1}), of the base sequence codeword, \vec{b}=(b₀, . . . , b_{L-1}).

Accordingly, rather than designing a base sequence codebook of base sequence codewords, \vec{b}, aspects of the present application may relate to designing an IDFT codebook for an IDFT delay domain, where the IDFT codebook is made up of IDFT codewords, \vec{B}.

The IDFT codebook may be described as a set, B, having a quantity, M, of IDFT codewords, \vec{B}, that is, B=[\vec{B}₁, . . . , \vec{B}_{M}]. It should be clear that the i^{th} IDFT codeword, \vec{B}ᵢ, is the IDFT of the i^{th} base sequence codeword, \vec{b}ᵢ=(b_{i,0}, . . . , b_{i,L-1}). It should be clear that, since an IDFT is a unitary transformation, a Euclidean distance between two base sequence codewords is the same as a Euclidean distance between two IDFT codewords. It follows that an objectively good codebook in the IDFT domain will correspond to an objectively good codebook in the base sequence domain.

Aspects of the present application relate to determining the features that are desired in the IDFT domain to facilitate sensing detection.

To facilitate sensing detection, it is proposed to simplify detection of the true delay, τⱼ. It may be shown that detection of the true delay, τⱼ, may be simplified by implementing a feature wherein the symbols, b_{i,n}, in each base sequence codeword, \vec{b}ᵢ, in the base sequence codebook are constrained such that |b_{i,0}|²>γ|b_{i,n}|² for all i and n>0 for some γ>1. The ratio, γ, that relates the power, |b_{i,0}|², in the first symbol to the power, |b_{i,n}|², in each of the rest of the symbols may be referred to as a power ratio.

It is known that when the number of non-zero pulses is limited, the result is a sparse codebook design. Accordingly, aspects of the present application relate to limiting the number of non-zero sinc pulses.

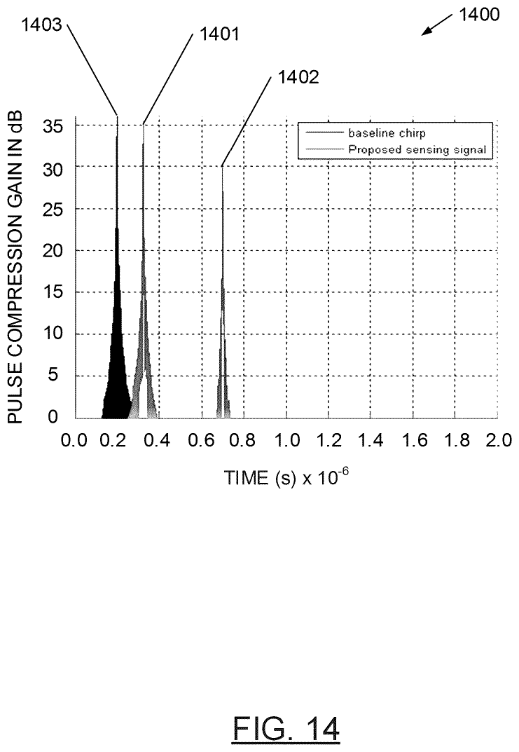

FIG. 14 illustrates a plot 1400 of output power with respect to delay for output from the chirp processing receiver 802B in FIG. 8B given a received sensing signal as input. Three output patterns are illustrated in the plot 1400 of FIG. 14, with each output pattern having a peak associated with a reference numeral.

The reference numeral 1401 is associated with a first peak, representative of an output power pattern that is expected to be generated by the chirp processing receiver 802B responsive to a scenario wherein the received sensing signal is a received version of a chirp signal that been modulated by a signature function, s(t), that makes use of a base sequence derived from a base sequence codeword, b, where the base sequence codeword, b, corresponds to an IDFT codeword, B=(0,2,0,0,1,0, . . . ,0), designed with a power ratio, γ=4. The first peak 1401 may be associated with a first location, τ_{obs1} (not shown), on the time axis.

The reference numeral 1402 is associated with a second peak, representative of an output power pattern that is expected to be generated by the chirp processing receiver 802B responsive to a scenario wherein the received sensing signal is a received version of a chirp signal that has been modulated by a signature function, s(t), that makes use of a base sequence derived from a base sequence codeword, b, where the base sequence codeword, b, corresponds to an IDFT codeword, B=(0,2,0,0,1,0, . . . ,0), designed with the power ratio, γ=4. The second peak 1402 may be associated with a second location, τ_{obs2} (not shown), on the time axis. It is worth underlining that the first peak 1401 and the second peak 1402 relate to a received version of a single chirp signal that has been modulated by a single signature function, s(t).

The reference numeral 1403 is associated with a third peak, representative of an output power pattern that is expected to be generated by the chirp processing receiver 802B responsive to receiving a sensing chirp signal that is unaffected by a signature function, or with a signature function, s(t)=1. The third peak 1403 may be associated with a true location, τₜᵣᵤₑ (not shown), on the time axis.

In the plot 1400 of FIG. 14, there is a difference between the power of the first peak 1401 and the power of the third peak 1403.

It may be shown that the first location, τ_{obs1}, and the second location, τ_{obs2}, (generically, τ_{obs}) have a deterministic relation with the true location, τₜᵣᵤₑ, given as a relation expressed as

$${τ}_{obs} = {τ}_{true} + \frac{k * T}{L}$$

for integer values, k*. The variable, k*, is used to represent indices of non-zero elements in the particular IDFT codeword that is in use.

Notably, since sensing performance does not depend on the phase of the symbols, b_{i,n}, of the in-use base sequence codeword, \vec{b}, information may be embedded on the phase as well (e.g., using phase shift keying modulation).

To summarize, aspects of the present application relate to use of an IDFT codebook that has been designed such that each IDFT codeword, in the IDFT codebook, has been defined based on a sparsity pattern.

The task of defining each particular IDFT codeword may take into account features of the particular base sequence codeword, \vec{b}, that corresponds to each particular IDFT codeword. Such defining may begin with assuming an ON state for the first symbol, b₀, of the base sequence codeword, \vec{b}, corresponding to each IDFT codeword. Such defining may also establish an inequality that states |b_{i,0}|²>γ|b_{i,n}|² for the base sequence codeword, \vec{b}, corresponding to each IDFT codeword. Furthermore, a pre-determined limit value, Kₘₐₓ, may be established for a number, K, of non-zero elements in each IDFT codeword. Alternatively, a non-sparsity ratio,

$$\frac{K}{L} ,$$

may be defined and, then, a pre-determined limit value,

$$\frac{{K}_{max}}{L} ,$$

may be established for the non-sparsity ratio.

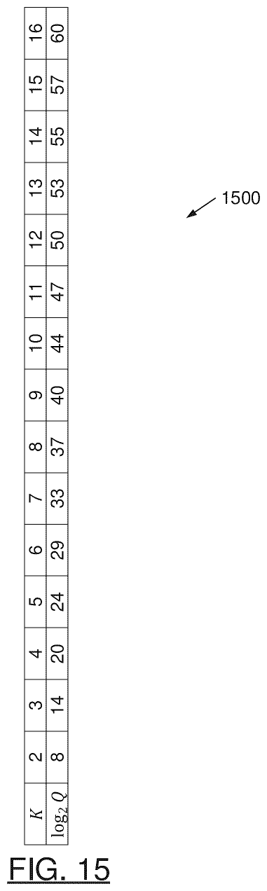

A multi-dimensional constellation may be defined over the non-zero elements of each IDFT codeword. In a special case, an independent phase shift keying constellation may be defined over the elements of each IDFT codeword. FIG. 15 illustrates a table 1500 that associates a quantity, Q, of total possible number of signature functions, s(t), (presented as logarithm in base 2) in terms of the number, K, of non-zero IDFT codeword elements for a scenario wherein L=32, BT=1024, Kₘₐₓ=16, and a quadrature phase shift keying constellation is employed.

Aspects of the present application relate to signaling mechanisms.

For one example, it should be clear that one or more signaling mechanisms may be specified to allow a TRP 170 (see FIG. 6) to provide, to a UE 110 (see FIG. 6), an indication of chirp signal configuration parameters. As discussed hereinbefore, chirp signal configuration parameters may include bandwidth, time duration, chirp rate and initial frequency.

All presented methods are described for a single chirp signal. It should be appreciated that the presented methods can readily be extended to a case wherein a plurality of chirp signals are concatenated in the time domain (FMCW waveform). In this case, the signature function, s(t), can be applied to the whole waveform, or the signature function can be applied to each chirp signal individually, i.e., Sᵢ(t) is applied to the ith chirp signal, i=1, . . . , M, wherein M denotes the total number of chirp signals. In this case, an aggregate signature function can be defined as S(t)=[S₁(t), . . . , S_{M}(t)]. In this case, definition of each individual signature function, Sᵢ(t), can follow the presented methods.

Various methods are contemplated to allow a given TRP 170 or a given UE 110 to determine one or more chirp signal configuration parameters. One method relies upon one or more of the chirp signal configuration parameters being mapped to a sensing transmitter ID, a sensing receiver ID or a sensing session ID. The sensing session ID may, for example, be determined on the basis of a sensing transmitter Radio Network Temporary Identifier (RNTI). One of the chirp signal configuration parameters may be called a digital signature indication. The digital signature indication may be used to provide an indication of whether or not a sensing chirp signal that is to be transmitted should be expected to be a chirp signal modulated by a signature function.

When a TRP 170 is using signaling to provide, to a UE 110, an indication of chirp signal configuration parameters, the TRP 170 may use dynamic signaling or semi-static signaling. In a case wherein the sensing signal is a chirp signal modulated by a signature function, two designs are contemplated.

A first design may be used for the frequency hopping implementation of the signature function, an example of which implementation is illustrated in FIG. 9. In the first design, the chirp signal configuration parameters signaled from the TRP 170 to the UE 110 may be expected to include a signature vector, r, (or an indication of the signature vector, r, such as an index of the signature vector, r) and a chirp rate. Instead of signaling the signature vector, r, the TRP 170 may signal an indication of the signature vector, r, such as an index or a pointer to a signature vector, r, stored, at the UE 110, among many signature vectors. The TRP 170 may signal the chirp signal configuration parameters through semi-static signaling. An example of such semi-static signaling is the known RRC signaling. Instead of the chirp signal configuration parameters including a signature vector, r, the chirp signal configuration parameters may include a frequency vector, f, or a pointer to a frequency vector, f.

A second design may be used for the base sequence codebook implementation of the signature function, an example of which implementation is illustrated in FIG. 12. In the second design, the chirp signal configuration parameters signaled from the TRP 170 to the UE 110 may be expected to include a base sequence codebook. The TRP 170 may signal the chirp signal configuration parameters through semi-static signaling. An example of such semi-static signaling is the known RRC signaling.

Recall that an IDFT codebook may be defined based on a sparsity pattern or based on a combination of a sparsity pattern and a regular constellation. Accordingly, it may be the case that there is reason that the IDFT codebook parameters are to be signaled from the TRP 170 to the UE 110. The IDFT codebook parameters may include parameters discussed hereinbefore, such as: an integer value, L; a pre-determined limit value, Kₘₐₓ, for the number, K, of non-zero elements in each IDFT codeword; a modulation order; and a power ratio, γ, between the first element and the rest of the elements in each IDFT codeword. The IDFT codebook may be defined dynamically by the TRP 170. The defining may be based on sensing resources, required sensing accuracy and/or resolution, sensing environment including number of dominant reflectors and/or scatterers, number of sensing Tx-Rx pairs in a given region, etc. The IDFT codebook parameters may be signaled, from the TRP 170 to the UE 110, through semi-static signaling.

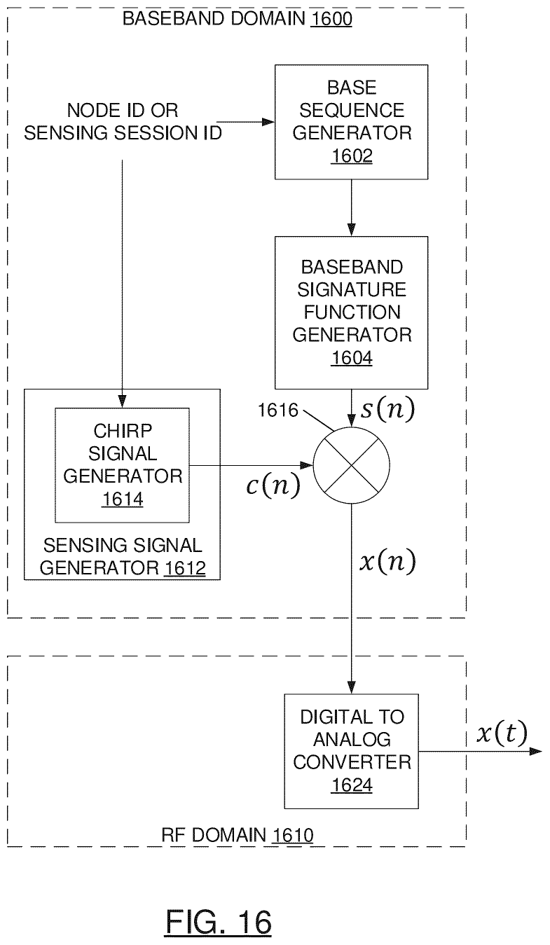

FIG. 16 illustrates transmitter elements involved in generating a sensing signal, x(t), for transmission. In common with the arrangement illustrated in FIG. 7, some of the generating takes place in a baseband domain 1600 and some of the generating takes place in an RF domain 1610.

In contrast to the arrangement illustrated in FIG. 7, the baseband domain 1600 includes a base sequence generator 1602 and a baseband signature function generator 1604. The baseband domain 1600 also includes sensing signal generator 1612 and a multiplier 1616. The sensing signal generator 1612 includes a chirp signal generator 1614. The RF domain 1610 includes a digital to analog converter 1624.

In operation, the base sequence generator 1602 may receive, as input, a node ID or a sensing session ID. On the basis of the received ID, the base sequence generator 1602 may determine an index (a “codeword index”) that allows the base sequence generator 1602 to select a particular codeword from among a plurality of codewords in a codebook. On the basis of the codeword index, the base sequence generator 1602 may transmit, to the baseband signature function generator 1604, a base sequence. On the basis of the base sequence, the baseband signature function generator 1604 may generate a discrete signature function, s(n). The baseband signature function generator 1604 may then provide, to the multiplier 1616, the discrete signature function, s(n). The chirp signal generator 1614 may also receive, as input, the same node ID or the same sensing ID that was provided to the base sequence generator 1602. On the basis of the node ID or the sensing session ID, the chirp signal generator 1614 may select a starting frequency, fᵢ, and a chirp rate, α. Using the selected starting frequency, fᵢ, and the selected chirp rate, α, the chirp signal generator 1614 may generate a discrete chirp signal, c(n). The discrete chirp signal, c(n), at the output of the chirp signal generator 1614 may be multiplied, at the multiplier 1616, with the discrete signature function, s(n), to, thereby, generate a discrete sensing signal, x(n). The node ID may be an identity associated with the sensing transmitter (e.g., the first TRP 170-1 in FIG. 6) or an identity associated with the sensing receiver (e.g., the first UE 110-1 in FIG. 6). Upon receipt of the discrete sensing signal, x(n), the digital to analog converter 1624 may convert the discrete sensing signal, x(n), to a continuous sensing signal, x(t), for transmission.

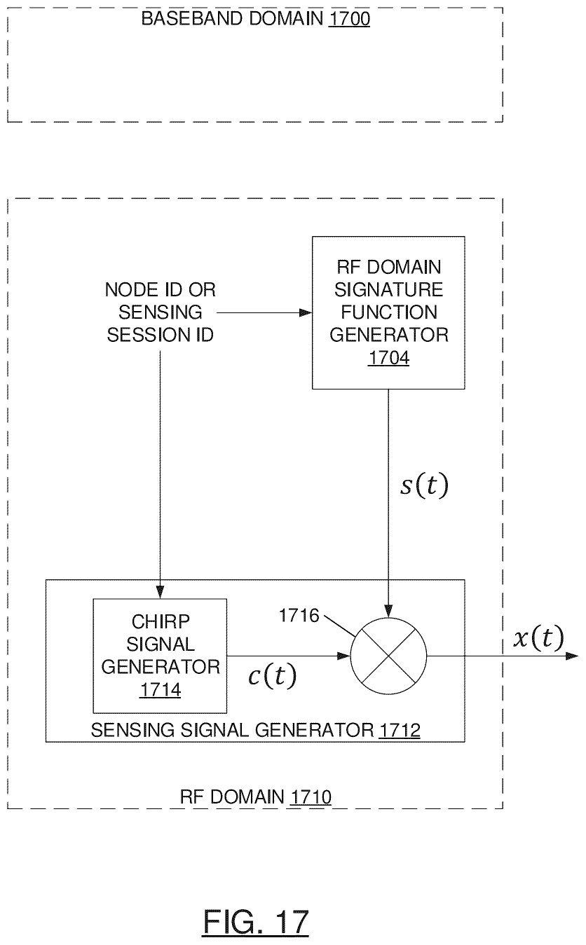

FIG. 17 illustrates transmitter elements involved in generating a sensing signal, x(t), for transmission. In common with the arrangement illustrated in FIG. 7, FIG. 17 illustrates a baseband domain 1700 and an RF domain 1710. In contrast to the arrangement illustrated in FIG. 7, none of the generating takes place in the baseband domain 1700.

The RF domain 1710 includes an RF domain signature function generator 1704 and a sensing signal generator 1712. The sensing signal generator 1712 includes a chirp signal generator 1714 and a modulator 1716. The modulator 1716 may be implemented as a multiplier.

In operation, the RF domain signature function generator 1704 may receive, as input, a node ID or a sensing session ID. On the basis of the received ID, the RF domain signature function generator 1704 may generate an RF domain signature function, s(t). An RF domain signature function has been introduced hereinbefore as a frequency hopping implementation for the design of the signature function, s(t), discussed in conjunction with a description of FIG. 9. The RF domain signature function generator 1704 may then provide, to the multiplier 1716, the RF domain signature function, s(t). The chirp signal generator 1714 may also receive, as input, the same node ID or the same sensing ID that was provided to the RF domain signature function generator 1704. On the basis of the node ID or the sensing session ID, the chirp signal generator 1714 may select a starting frequency, fᵢ, and a chirp rate, α, for the chirp signal, c(t). The chirp signal, c(t), at the output of the chirp signal generator 1714 may be modulated, at the modulator 1716, with the signature function, s(t), to, thereby, generate the sensing signal, x(t).

In some embodiments, a device or apparatus includes the transmitter elements and/or the receiver elements, to perform the method of the present disclosure.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
generating a linearly frequency modulated signal;
generating a signature function;
obtaining a sensing signal by modulating the linearly frequency modulated signal with the signature function; and
transmitting the sensing signal.

2. The method of claim 1, further comprising:
generating a base sequence,
wherein the generating the signature function comprises:
generating the signature function based at least in part on the base sequence.

3. The method of claim 2, wherein the generating the base sequence comprises:
receiving an identity of a node; and
generating the base sequence based at least in part on the identity of the node.

4. The method of claim 3, wherein the node comprises a sensing transmitter or a sensing receiver.

5. The method of claim 2, wherein the generating the base sequence comprises:
receiving a sensing session identity; and
generating the base sequence based at least in part on the sensing session identity.

6. The method of claim 1, wherein the generating the linearly frequency modulated signal comprises:
receiving an identity of a node; and
generating the linearly frequency modulated signal based at least in part on the identity of the node.

7. The method of claim 1, wherein the generating the linearly frequency modulated signal comprises:
receiving an identity of a sensing session; and
generating the linearly frequency modulated signal based at least in part on the identity of the sensing session.

8. An apparatus comprising:
one or more processors coupled with a memory storing instructions which, when executed by the one or more processors, cause the apparatus to perform operations including:
generating a linearly frequency modulated signal;
generating a signature function;
obtaining a sensing signal by modulating the linearly frequency modulated signal with the signature function; and
transmitting the sensing signal.

9. The apparatus of claim 8, the operations further comprising:
generating a base sequence,
wherein the generating the signature function comprises:
generating the signature function based at least in part on the base sequence.

10. The apparatus of claim 9, wherein the generating the base sequence comprises:
receiving an identity of a node; and
generating the base sequence based at least in part on the identity of the node.

11. The apparatus of claim 10, wherein the node comprises a sensing transmitter or a sensing receiver.

12. The apparatus of claim 9, wherein the generating the base sequence comprises:
receiving a sensing session identity; and
generating the base sequence based at least in part on the sensing session identity.

13. The apparatus of claim 8, wherein the generating the linearly frequency modulated signal comprises:
receiving an identity of a node; and
generating the linearly frequency modulated signal based at least in part on the identity of the node.

14. The apparatus of claim 8, wherein the generating the linearly frequency modulated signal comprises:
receiving an identity of a sensing session; and
generating the linearly frequency modulated signal based at least in part on the identity of the sensing session.

15. A non-transitory computer-readable storage medium having instructions stored thereon which, when executed, cause an apparatus to perform operations, the operations comprising:
generating a linearly frequency modulated signal;
generating a signature function;
obtaining a sensing signal by modulating the linearly frequency modulated signal with the signature function; and
transmitting the sensing signal.

16. The non-transitory computer-readable storage medium of claim 15, the operations further comprising:
generating a base sequence;
wherein the generating the signature function comprises:
generating the signature function based at least in part, on the base sequence.

17. The non-transitory computer-readable storage medium of claim 16, wherein the generating the base sequence comprises:
receiving an identity of a node; and
generating the base sequence based at least in part on the identity of the node.

18. The non-transitory computer-readable storage medium of claim 17, wherein the node comprises a sensing transmitter or a sensing receiver.

19. The non-transitory computer-readable storage medium of claim 16, wherein the generating the base sequence comprises:
receiving a sensing session identity; and
generating the base sequence based at least in part on the sensing session identity.

20. The non-transitory computer-readable storage medium of claim 15, wherein the generating the linearly frequency modulated signal comprises:
receiving an identity of a node; and
generating the linearly frequency modulated signal based at least in part on the identity of the node.
